(19) United States
(12) Patent Application Publication
(10) Pub. No.: US 2025/0193318 A1
(43) Pub. Date: Jun. 12, 2025

(54) IMAGE INSPECTION APPARATUS, IMAGE INSPECTION METHOD, AND RECORDING MEDIUM

(71) Applicant: Konica Minolta, Inc., Tokyo (JP)

(72) Inventor: Yasumasa Tsukamoto, Tokyo (JP)

(73) Assignee: Konica Minolta, Inc., Tokyo (JP)

(21) Appl. No.: 18/933,496

(22) Filed: Oct. 31, 2024

(30) Foreign Application Priority Data
Dec. 11, 2023 (JP) 2023-208363

(51) Int. Cl. H04N 1/00; G06T 7/00

(52) U.S. Cl. CPC H04N 1/00029; G06T 7/001; H04N 1/00045; G06T 2207/30144

(57) ABSTRACT

This image inspection apparatus includes an image former and a hardware processor. The image former forms an image on a recording medium on the basis of the acquired image data. The hardware processor generates a reference image to be used for inspection of the image formed on the recording medium, and inspects the image formed on the recording medium on the basis of the reference image. The image inspection apparatus has a first inspection mode in which the reference image is registered at a predetermined timing in an image forming process of forming the image to be inspected by the image former and a second inspection mode in which the reference image is not registered at the predetermined timing.

### CROSS-REFERENCE TO RELATED APPLICATION

Japanese patent application No. 2023-208363 filed on Dec. 11, 2023, including description, claims, drawings, and abstract the entire disclosure is incorporated herein by reference in its entirety.

### BACKGROUND OF THE INVENTION

### 1. Technical Field

The present invention relates to an image inspection apparatus, an image inspection method, and a computer-readable recording medium storing an image inspection program.

### 2. Description of Related Art

Conventionally, a method for inspecting a printed product by comparison between a document image as a reference image and a read image obtained by reading a printing sheet (printed product) on which an inspection image is printed has been known. For example, Japanese Unexamined Patent Application Publication No. 2015-53561 discloses a printed product inspection device that inspects the quality of a printed product by comparing a document image as a reference image with a read image of the printed product.

### SUMMARY OF THE INVENTION

However, the printed product inspection device disclosed in Japanese Unexamined Patent Application Publication No. 2015-53561 needs to complete the generation of the reference image (steps S101 to S115 in FIG. 6) before the generation of the inspection image (step S117 in FIG. 6) is started. Therefore, there is a problem that considerable time is still required for the processing from the generation of the reference image (steps S101 to S115 in FIG. 6) to the image inspection (steps S117 to S119 in FIG. 6).

Furthermore, when a printed product obtained by printing, by additional printing, an image on the printed surface of a sheet having an image already printed thereon based on a document image is inspected with the document image being used as a reference image, an error may occur even if there is no problem with the quality of the printed product. Therefore, when a printed product obtained by additional printing is inspected, it is necessary to register, as a reference image, a printed product confirmed by a user to have no quality problem among printed products obtained by additional printing.

The present invention has been made in view of the above-mentioned circumstances. An object of the present invention is to provide an image inspection apparatus, an image inspection method, and a computer-readable recording medium storing an image inspection program, with which it is possible to improve productivity of inspection of a printed product obtained by printing which does not require pre-registration of a reference image, and also to appropriately inspect a printed product obtained by printing which requires pre-registration of a reference image.

To achieve at least one of the abovementioned objects, according to an aspect of the present invention, an image inspection apparatus reflecting one aspect of the present invention comprises the followings.

An image inspection apparatus including: an image former that forms an image on a recording medium on the basis of acquired image data; and a hardware processor, the hardware processor generating a reference image to be used for inspection of the image formed on the recording medium, and inspecting the image formed on the recording medium on the basis of the reference image, the image inspection apparatus having a first inspection mode in which the reference image is registered at a predetermined timing in an image forming process of forming the image to be inspected by the image former and a second inspection mode in which the reference image is not registered at the predetermined timing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic block diagram of a printing system according to an embodiment of the present invention;

FIG. 2 is a schematic block diagram illustrating the configuration of an image forming system illustrated in FIG. 1;

FIG. 3 is a block diagram for describing the outline of a control operation of a controller and a print controller in a process of generating a reference image in a first inspection mode;

FIG. 4 is a block diagram for describing the outline of a control operation of the controller and the print controller in a process of inspecting an inspection image in the first inspection mode;

FIG. 5 is a block diagram for describing the outline of a control operation of the controller and the print controller in a second inspection mode;

FIG. 6 is a flowchart illustrating an image inspection method according to an embodiment of the present invention;

FIG. 7 is a subroutine flowchart illustrating execution of the first inspection mode (step S102) in the flowchart illustrated in FIG. 6;

FIG. 8 is a subroutine flowchart subsequent to FIG. 7;

FIG. 9 is a schematic diagram illustrating, in a time-series manner, processing of acquiring a document image and processing of generating a reference image in a reference image generation process;

FIG. 10 is a schematic diagram illustrating, in a time-series manner, processing of acquiring a document image, processing of forming an inspection image, and processing of inspecting the inspection image in an image forming process;

FIG. 11 is a subroutine flowchart illustrating execution of a second inspection mode (step S103) in the flowchart illustrated in FIG. 6; and

FIG. 12 is a schematic diagram illustrating, in a time-series manner, processing of acquiring a document image, processing of generating a reference image, processing of forming an inspection image, and processing of inspecting the inspection image.

### DETAILED DESCRIPTION

Hereinafter, one or more embodiments of the present invention will be described with reference to the drawings. However, the scope of the invention is not limited to the disclosed embodiments. Note that in the description of the drawings, the same components are denoted by the same reference signs, and redundant descriptions will not be repeated. In addition, dimensional ratios in the drawings are exaggerated for convenience of description and may be different from actual ratios.

### <Configuration of Printing System>

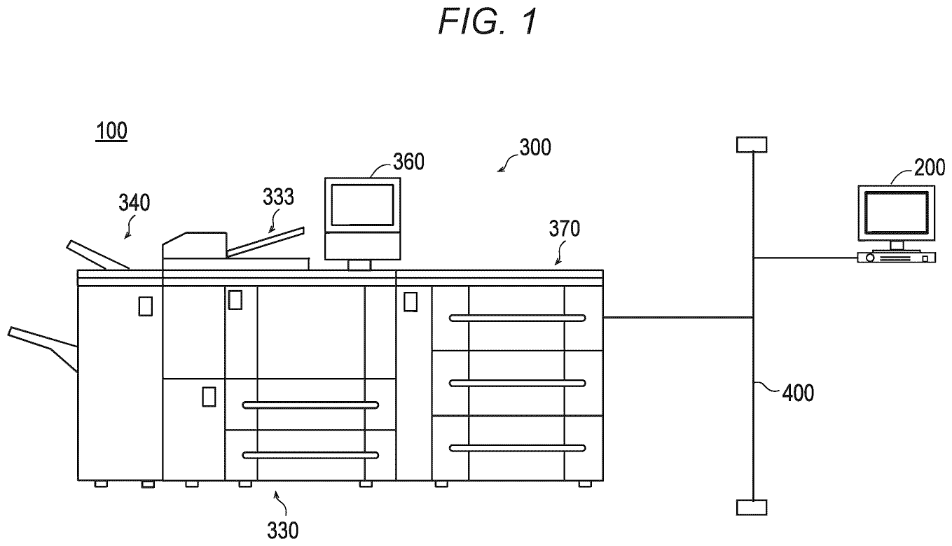

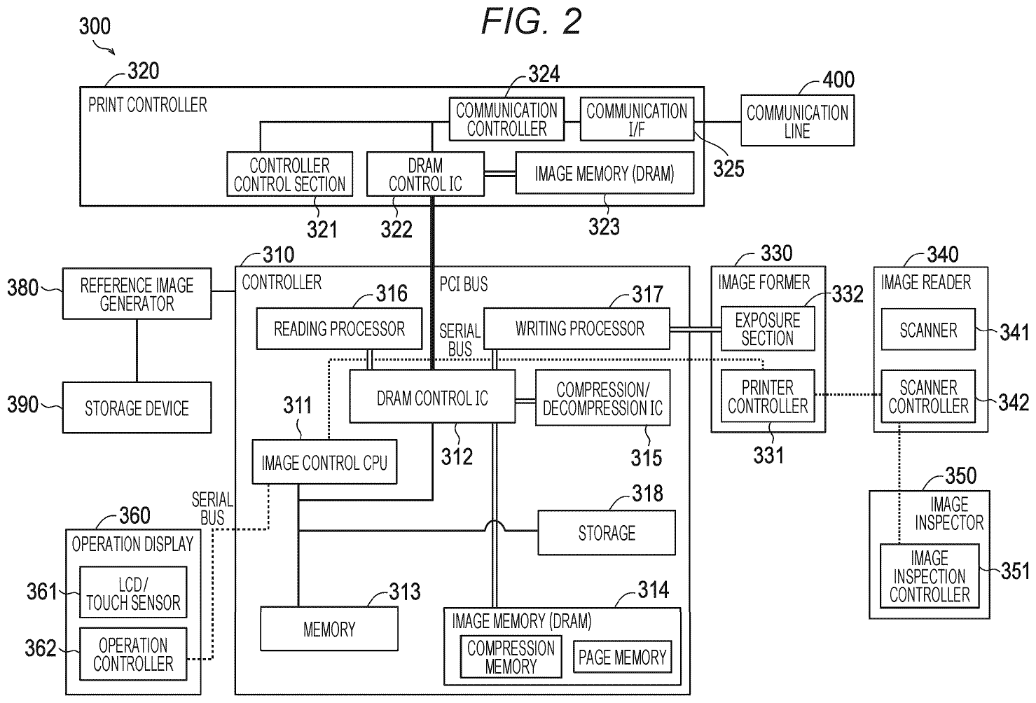

FIG. 1 is a schematic block diagram of a printing system according to an embodiment of the present invention, and FIG. 2 is a schematic block diagram illustrating the configuration of an image forming system illustrated in FIG. 1.

As illustrated in FIG. 1, a printing system 100 includes a client terminal 200 and an image forming system 300. The client terminal 200 and the image forming system 300 are communicably connected to each other via a communication line 400.

The client terminal 200 may be, for example, a personal computer, a tablet terminal, a smartphone, or the like. A printer driver for converting document data into a print job is installed in the client terminal 200. The printer driver generates a print job in a format compatible with a print controller 320 (see FIG. 2) of the image forming system 300, and transmits the print job to the image forming system 300 via the communication line 400. In addition, the client terminal 200 includes a display, and can display an inspection result (non-defective/defective) of a printed product, an image of a defective printed product, and the like.

The print job includes a reference image generation job and an inspection job. The inspection job includes, for example, print data in a page description language (PDL) format and job information. The print data includes, for example, data of first to n-th pages. The job information includes, for example, print settings such as the number of pages, the number of copies, the type, size, and basis weight of a sheet (recording medium), single-sided printing/double-sided printing, inspection setting (on/off), and a printing mode. The printing mode includes, for example, a normal printing mode and an additional printing mode. A user can instruct the image forming system 300 to perform image inspection by turning on the inspection setting.

The communication line 400 may include a local area network (LAN) in which computers and network devices are connected to each other according to a predetermined standard, a wide area network (WAN) in which LANs are connected to each other by a dedicated line, or the like. The predetermined standard is, for example, Ethernet (registered trademark), fiber distributed data interface (FDDI), wireless fidelity (Wi-Fi), or the like.

Note that the number of the above constituent elements connected to the communication line 400 is not limited to the number illustrated in FIG. 1.

### <Configuration of Image Forming System 300>

As illustrated in FIGS. 1 and 2, the image forming system 300 includes a controller 310, a print controller 320, an image former 330, an image reader 340, an image inspector 350, an operation display 360, a sheet feeder 370, a reference image generator 380, and a storage device 390. The image forming system 300 functions as an image inspection apparatus.

### <Configuration of Controller 310>

The controller 310 includes an image control central processing unit (CPU) 311, a dynamic random access memory (DRAM) control IC 312, a memory 313, an image memory (DRAM) 314, a compression/decompression IC 315, a reading processor 316, a writing processor 317, a storage 318, and the like.

The image control CPU 311 develops various programs stored in the storage 318 in the memory 313, and comprehensively controls the operation of the entire image forming system 300 in cooperation with the developed programs.

The reading processor 316 performs various kinds of processing such as analog processing, A/D conversion processing, and shading processing on an analog image signal output from a scanner 341 of the image reader 340, and generates digital image (read image) data. The generated digital image data is output to the compression/decompression IC 315 by the DRAM control IC 312. Under the control of the DRAM control IC 312, the compression/decompression IC 315 performs compression processing on digital image data and decompression processing on the digital image data after the compression processing.

Furthermore, the DRAM control IC 312 controls input and output of the digital image data subjected to the compression and decompression processing to and from the image memory (DRAM) 314.

The image memory 314 is formed of a DRAM, includes regions of a compression memory and a page memory therein, and temporarily stores compressed image data, decompressed image data, and the like.

The writing processor 317 outputs the decompressed digital image data to an exposure section 332 of the image former 330.

### <Configuration of Print Controller 320>

The print controller 320 analyzes the print job received from the client terminal 200 via the communication line 400, performs processing such as color conversion, screening, and rasterization, and generates a document image in a bitmap format. The generated document image is transmitted to the controller 310. The print controller 320 functions as a document image acquirer.

The print controller 320 includes a controller control section 321, a DRAM control IC 322, an image memory (DRAM) 323, a communication controller 324, and a communication interface (I/F) 325. The controller control section 321 comprehensively controls operation of each section of the print controller 320. Further, the controller control section 321 receives the print job from the client terminal 200 or the like via the communication I/F 326. The communication controller 324 controls the communication I/F 325.

The received print job includes print data serving as a source of a document image and job information in which print settings such as the type of a sheet to be used are described. The print data is mainly in a PDL format. The print controller 320 performs rasterization (RIP) processing for converting print data into bitmap data in units of pages based on the print settings. The RIP image after the rasterization processing is temporarily stored in the image memory 323. The RIP image in the image memory 323 is temporarily stored in the compression memory region in the image memory 314 via the compression/decompression IC 315 under the control of the DRAM control IC 322 of the print controller 320 and the DRAM control IC 312 of the controller 310. At the time of normal printing, the RIP image stored in the compression memory region is decompressed by the compression/decompression IC 315 and is transmitted to the image former 330 as a document image (image data) via the writing processor 317, and the transmitted RIP image is printed.

The controller 310 outputs, at a predetermined generation timing, a reference image generation instruction to the reference image generator 380, which will be described later, to generate a reference image based on the document image. The reference image generator 380 generates the reference image based on the reference image generation instruction.

Ideally, a read image generated by reading an inspection image formed on a sheet is considered to match the document image in terms of content. However, when the inspection image formed on the sheet is read by the scanner, an error may occur in the read image with respect to the document image due to various factors such as variations in a conveyance path for the sheet, a reading position shift by the scanner, color reproducibility, and a difference in paper type. An error may also occur in the document image depending on the resolution of reading by the scanner. Therefore, when the read image and the document image are simply compared, an error is highly likely to occur, and it is not realistic to inspect the inspection image by simply comparing the read image with the document image. In view of this, the present embodiment is configured to generate a reference image by performing various kinds of processing on the document image in terms of position, resolution, color, and the like so that the reference image can be compared with the read image, and to compare the reference image and the read image. Thus, the reference image can be appropriately compared with the read image, whereby the printed product can be accurately inspected. Details of the processing of generating the reference image will be described later.

### <Configuration of Image Former 330>

The image former 330 forms (prints) an image on a sheet with an electrophotographic method including processing of charging, exposure, development, transfer, and fixing, in accordance with an instruction from the controller 310. In the present embodiment, the image former 330 forms an inspection image to be inspected by the image inspector 350 on a sheet under an image forming condition set based on the print settings. The image former 330 includes a printer controller 331, the exposure section 332, and the like. The printer controller 331 is connected to the image control CPU 311 by serial communications, and receives control by the image control CPU 311. The printer controller 331 drives a laser diode (LD) of the exposure section 332 in response to a signal from the writing processor 317, and forms an electrostatic latent image corresponding to a document image on a photoreceptor (not illustrated). The toner image formed on the photoreceptor is developed through development processing and is transferred onto a sheet supplied from the sheet feeder 370. Next, the unfixed toner image on the sheet is fixed by being heated and pressurized. The sheet on which the toner image has been fixed is conveyed to the image reader 340.

In addition, the image former 330 includes a printing sheet ejection device that ejects (purges) a sheet (waste sheet) having an inspection image that has been detected as abnormal by the image inspector 350 separately from a sheet on which a normal inspection image has been formed.

### <Configuration of Image Reader 340>

The image reader 340 includes the scanner 341 and a scanner controller 342. The scanner 341 reads a sheet (printed product) conveyed through the conveyance path with, for example, a charge coupled device (CCD) image sensor. The scanner controller 342 controls the scanner so that the scanner reads an inspection image formed on the sheet conveyed from the image former 330 according to a reading instruction from the controller 310. The scanner controller 342 outputs, to the controller 310, a read image obtained by reading the inspection image formed on the sheet.

### <Configuration of Image Inspector 350>

The image inspector 350 performs image inspection based on a reference image. More specifically, the image inspector 350 acquires the reference image and the read image, and compares the reference image with the read image page by page to inspect the inspection image formed on the sheet.

The image inspector 350 includes an image inspection controller 351. The image inspection controller 351 includes the image control CPU 311 or a CUP, a RAM, a ROM, and an auxiliary storage device (not illustrated). The function of inspecting an inspection image is implemented by the CPU executing an image inspection program. For example, the image inspection controller 351 calculates a difference (error) in pixel value between the reference image and the read image for each page, and determines the quality of the inspection image according to the magnitude of the difference. The difference can be calculated for each page, each object, or each region. For example, in a case where the difference is calculated for each page, an inspection result indicating “non-defective” is output when the total value of differences between pixels in one page is less than a specified value, and an inspection result indicating “defective” is output when the total value of the differences between the pixels in one page is equal to or more than the specified value. In addition, when the difference is calculated for each object or for each region, an inspection result indicating “non-defective” or “defective” is output according to the total value of differences between pixel values in the selected object or region.

When the result of inspecting the inspection image indicates “non-defective”, the controller 310 determines that the printed product is a non-defective product. When the result of inspecting the inspection image indicates “defective”, the controller 310 determines that the printed product is a defective product.

### <Configuration of Operation Display 360>

The operation display 360 includes a touch screen display 361, an operation controller 362, a numeric keypad as hardware keys, a start button, a stop button, and the like. The touch screen display includes, for example, a touch sensor and a liquid crystal display (LCD) disposed behind the touch sensor. The operation controller 362 receives input from the touch sensor and the hardware keys and transmits input data to the controller 310. Furthermore, the operation controller 362 receives output data from the controller 310 and displays the output data on the LCD. The operation display 360 is used for input of various settings (e.g., on/off of inspection setting) and instructions (e.g., instruction to start printing) by the user. The operation display 360 is also used to output (display) the state of the image forming system 300, a result (non-defective product or defective product) of inspecting a printed product, an image of a defective printed product, and the like.

### <Configuration of Sheet Feeder 370>

The sheet feeder 370 includes at least one large-capacity sheet tray, and supplies sheets one by one to the image former 330.

### <Configuration of Reference Image Generator 380>

The reference image generator 380 generates a reference image based on a document image acquired by the document image acquirer and outputs the reference image to the controller 310. The reference image generator 380 can be implemented by a CPU (not illustrated) executing the image inspection program. The CPU that executes the image inspection program is different from the image control CPU 311. Thus, in the second inspection mode to be described later, the generation of the reference image and the formation and inspection of the inspection image are executed in parallel. Alternatively, in a case where the image control CPU 311 is a multi-core CPU, the reference image generator 380 may be assigned to a core different from a core for the processing of forming and inspecting the inspection image, and the generation of the reference image and the formation and inspection of the inspection image may be performed in parallel by the different cores.

Note that conventionally, the same CPU has been configured to perform the generation of a reference image and the formation and inspection of an inspection image. Therefore, the CPU performs the formation and inspection of the inspection image after completing the generation of the reference image for each page, so that the generation of the reference image and the formation and inspection of the inspection image cannot be performed in parallel. The present embodiment is configured such that the generation of the reference image and the formation and inspection of the inspection image are performed by the different CPUs, whereby the generation of the reference image and the formation and inspection of the inspection image can be performed in parallel.

In addition, in a case where the document image is complex, a calculation load for generating the reference image may significantly increase. The CPU different from the image control CPU 311 generates the reference image, whereby the calculation load on the image control CPU 311 can be reduced.

### <Configuration of Storage Device 390>

The storage device 390 stores the reference image generated by the reference image generator 380. When the document image is reprinted, the controller 310 uses the reference image stored in the storage device 390. This eliminates the need to generate the reference image again. Therefore, the time required for generating the reference image can be saved.

### <Outline of Control Operation of Controller 310 and Print Controller 320>

### [Generation and Registration of Reference Image]

As described above, the reference image generator 380 generates a reference image for each page based on the document image. The controller 310 registers the reference image whose quality has been confirmed by the user as a reference image to be used for inspection of the inspection image. Note that the confirmation of the quality of the reference image can be omitted, as appropriate, according to a user's instruction, and the generated reference image can be immediately registered.

In this case, it is only sufficient that the generation of the reference image is completed before the inspection of the printed product as an object for inspection is started. For example, when generating a reference image based on a document image of a printed product obtained by additional printing, the controller 310 controls the reference image generator 380 so that the reference image generator 380 generates a reference image during a period from the acquisition of a reference image generation job to the formation of an image of a printed product as an object for inspection on a printed sheet.

In a case where the reference image is generated based on the document image, the generation of the reference image is started in response to the acquisition of the reference image generation job. Alternatively, a user's instruction may be received through the operation display 360 so that the timing of starting the generation of the reference image is adjusted.

Alternatively, instead of generating a reference image by the reference image generator 380, an image may be stored in advance in the storage device 390, and the stored image may be registered as a reference image in response to a user's instruction.

### [Inspection Mode]

The image forming system 300 has a plurality of inspection modes including a first inspection mode and a second inspection mode. The first inspection mode is an inspection mode in which a reference image is registered at a predetermined timing in the image forming process, by the image former 330, of forming the inspection image to be inspected by the image inspector 350. On the other hand, the second inspection mode is an inspection mode in which no reference image is registered at the predetermined timing. The controller 310 is configured to be able to execute any of a plurality of inspection modes including the first inspection mode and the second inspection mode. For example, the user can set the printing mode to the additional printing mode or the normal printing mode through the print setting of the job information. The controller 310 designates (selects) the first inspection mode when the additional printing mode is set, and designates the second inspection mode when the normal printing mode is set.

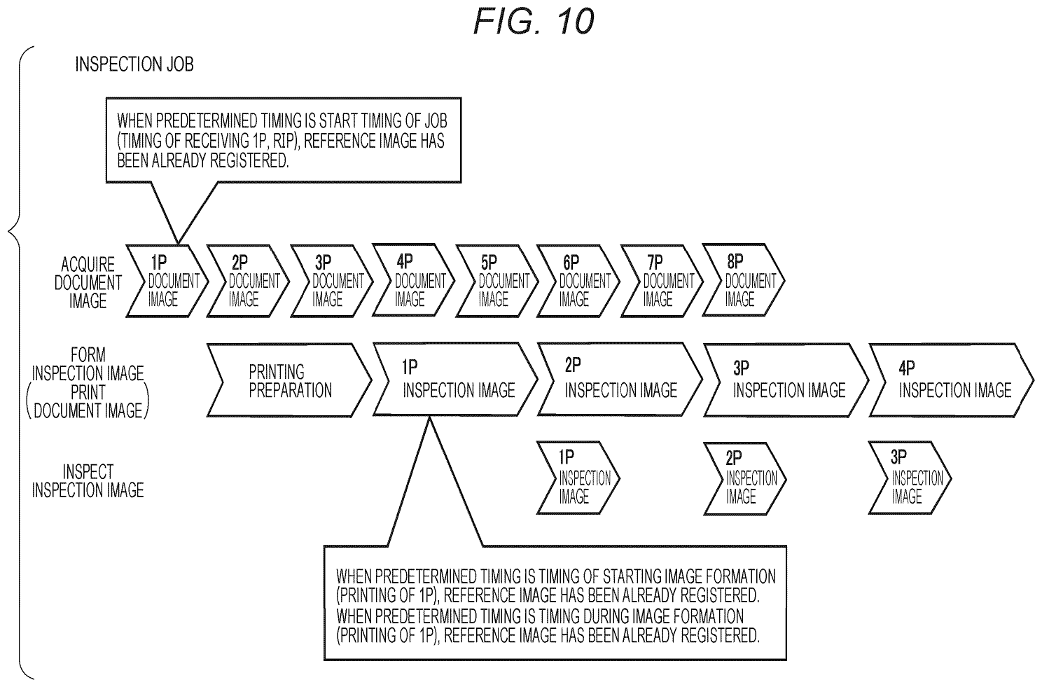

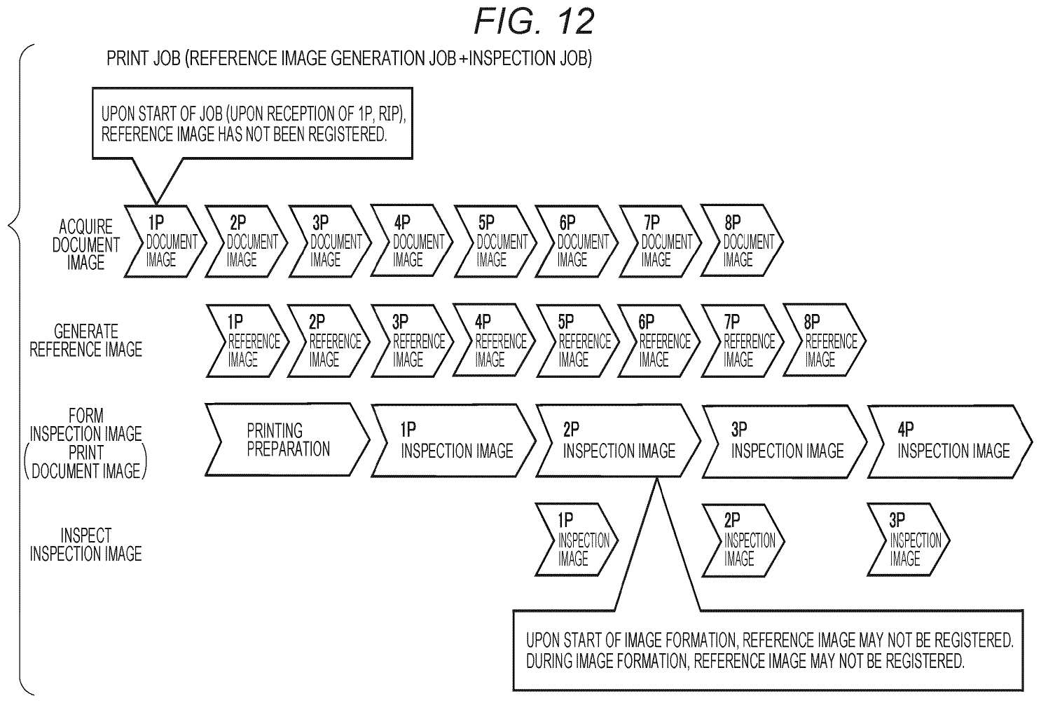

The image forming process is a process executed during a period from acquisition of a print job (inspection job) to formation of an inspection image on a sheet by the image former 330 based on a document image. The predetermined timing can include a timing of acquiring an inspection job. Furthermore, the predetermined timing can include an image formation start timing by the image former 330 or a timing during image formation. In a case where the document image includes images of a plurality of pages, the predetermined timing can include a timing during image formation of the inspection image based on at least the first page (e.g., refer to FIGS. 10 and 12).

In the first inspection mode, the image inspector 350 inspects the printed product as an object for inspection by using, for example, a reference image which has quality confirmed by the user and which has been registered by the user among the reference images generated by the reference image generator 380. Alternatively, the controller 310 registers, as a reference image, an image having quality confirmed in advance by the user among the images stored in the storage device 390, and the image inspector 350 inspects the printed product as an object for inspection using the registered reference image. For example, the controller 310 registers, as a reference image, a read image whose quality has been confirmed by the user among a plurality of read images generated by reading a printed product obtained by performing additionally printing on a printed sheet. The image inspector 350 inspects the printed product obtained by additional printing as an object for inspection using the registered reference image. Thus, when the printed product obtained by additional printing is inspected, it is possible to prevent an error that might occur in an inspection using the document image as the reference image even if there is no problem with the quality of the printed product.

On the other hand, no reference image is registered at the predetermined timing in the second inspection mode. The reference image is registered before the inspection of the inspection image is started. In the second inspection mode, the controller 310 controls the reference image generator 380 and the image former 330 so that the generation of the reference image and the formation of the inspection image on the sheet are performed in parallel. More specifically, the controller 310 executes a reference image generation process and an inspection process in parallel. The reference image generation process includes generating a reference image by the reference image generator 380 when the second inspection mode is designated as the inspection mode. The inspection process includes forming an inspection image on a sheet by the image former 330 and inspecting, by the image inspector 350, a read image generated by reading the sheet on which the inspection image is formed. Thus, the time required for the processing from the generation of the reference image to the image inspection can be shortened. As a result, the productivity of a printed product is improved.

As described above, in the present embodiment, the first inspection mode or the second inspection mode can be specified according to whether or not the reference image is registered at the predetermined timing. As described above, the printing mode includes the normal printing mode and the additional printing mode. When the additional printing mode is selected, a reference image is registered. The controller 310 executes the first inspection mode or the second inspection mode depending on whether or not the selected printing needs the pre-registration of the reference image, that is, the selected printing needs the registration of the reference image before the execution of the image forming process, such as additional printing. For example, the present embodiment may be configured such that the first inspection mode is executed when the printing mode is the additional printing mode, and the second inspection mode is executed when the printing mode is not the additional printing mode.

Furthermore, the present embodiment may be configured such that the first inspection mode is executed by the controller 310 when a reference image having quality intended by a user is registered in advance. Thus, the user's demand for the quality of the reference image can be reliably reflected.

The outline of the control operation of the controller 310 and the print controller 320 in each of the first inspection mode and the second inspection mode will be described below.

### [First Inspection Mode]

The inspection in the first inspection mode includes two processes: a process of generating a reference image; and a process of inspecting an inspection image. Each of these processes will be described below in detail.

### (Process of Generating Reference Image)

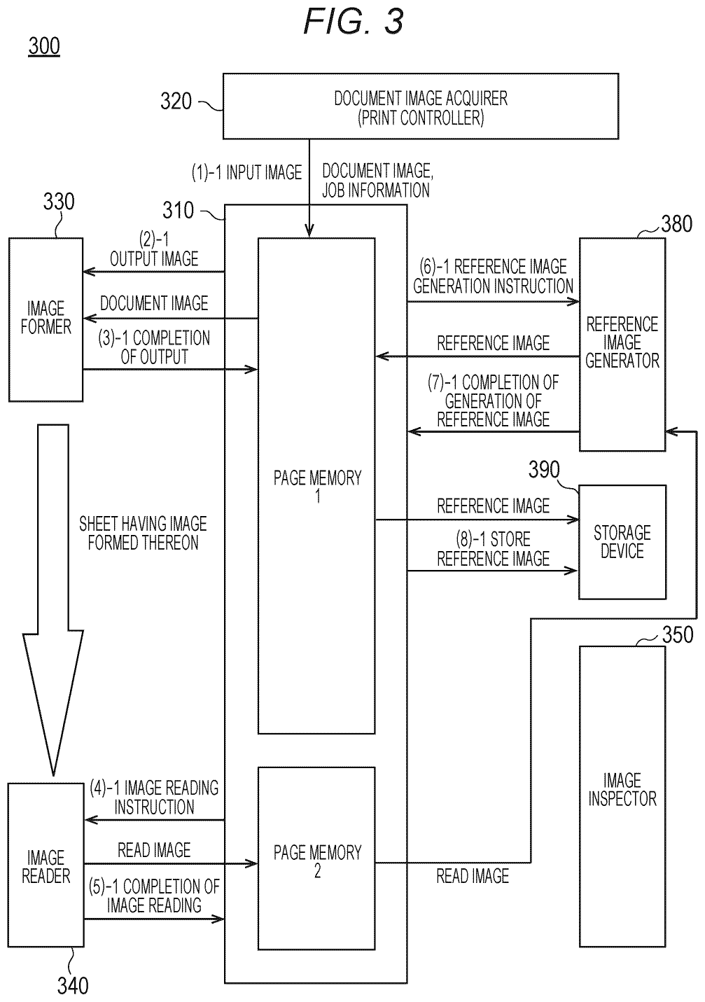

FIG. 3 is a block diagram for describing the outline of the control operation of the controller 310 and the print controller 320 in the process of generating a reference image in the first inspection mode.

First, the controller 310 receives a document image and job information from the document image acquirer (print controller 320) ((1)-1 input image). The document image is a RIP image obtained by rasterizing print data. The controller 310 stores the document image input by the document image acquirer in page memory 1.

Next, the controller 310 outputs the document image from page memory 1 to the image former 330 ((2)-1 output image), and the image former 330 forms an image on a sheet (printed sheet) based on the document image. After the completion of the sheet ejection, the image former 330 gives a notification indicating the completion of the sheet ejection to the controller 310 ((3)-1 completion of output).

Next, the controller 310 instructs the image reader 340 to read the image formed by the image former 330 ((4)-1 image reading instruction). The image reader 340 reads the image formed by the image former 330, stores the read image in page memory 2, and gives a notification indicating that the reading has been completed to the controller 310 ((5)-1 completion of image reading).

When receiving a reference image generation instruction from the controller 310 ((6)-1 reference image generation instruction), the reference image generator 380 generates a reference image based on the read image stored in page memory 2 and outputs the reference image to the controller 310. The controller 310 stores the reference image in page memory 1. After generating the reference image, the reference image generator 380 gives a notification indicating the completion of the generation of the reference image to the controller 310 ((7)-1 completion of generation of reference image). The controller 310 also stores the reference image stored in page memory 1 in the storage device 390 ((8)-1 store reference image).

The controller 310 repeats the processes (1)-1 to (8)-1 described above until the generation of the reference images is completed for all the pages of the printed product as an object for inspection.

As described above, the reference image generator 380 generates the reference image by performing various kinds of processing on the document image in terms of position, resolution, color, and the like. For example, in order that content portions (contents) of the reference image and the read image can be compared with each other, the reference image generator 380 can extract the position information of the content portion from the document image and add or embed the position information to or in the reference image. That is, the reference image generated by the reference image generator 380 includes alignment information for aligning the reference image and the read image when the image inspection is performed based on the reference image. Note that the alignment information includes outline information and edge information of the image. In addition, the reference image generated by the reference image generator 380 has region information regarding an inspection region and an inspection exclusion region used for the image inspection performed based on the reference image. Furthermore, the reference image generator 380 can generate a reference image by adjusting the resolution of the document image so as to match the resolution of the scanner of the image reader 340. Furthermore, the reference image generator 380 can generate a reference image by converting the color space of the document image so as to match the color space (e.g., RGB) adopted by the scanner of the image reader 340.

### (Process of Inspecting Inspection Image)

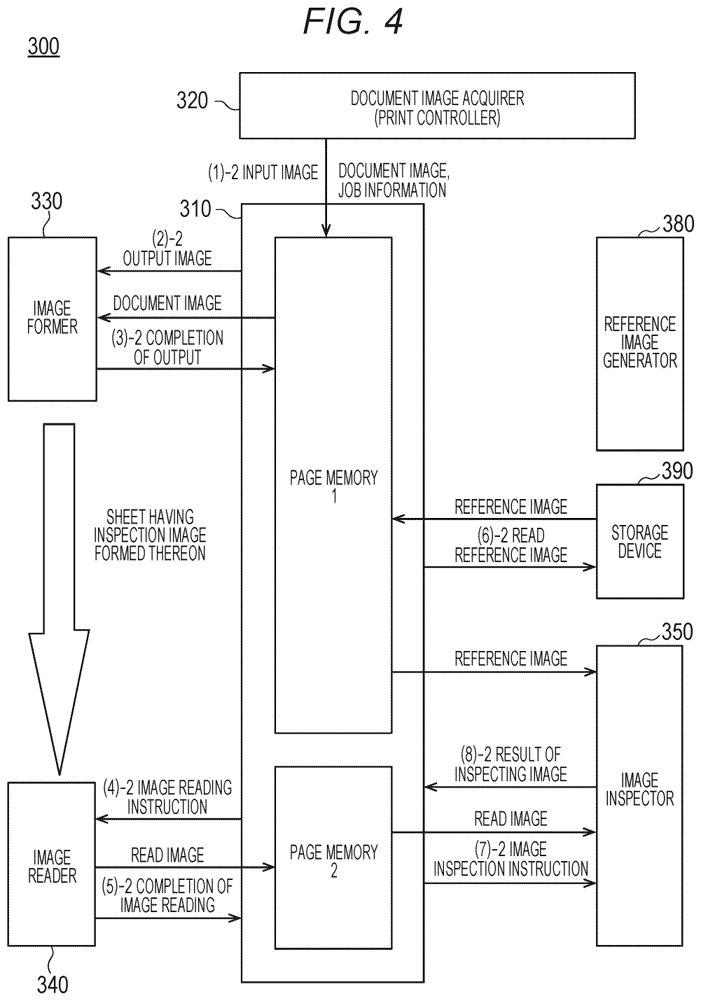

FIG. 4 is a block diagram for illustrating the outline of the control operation of the controller 310 and the print controller 320 in the process of inspecting the inspection image in the first inspection mode.

First, the controller 310 receives a document image and job information from the document image acquirer ((1)-2 input image). The document image is a RIP image obtained by rasterizing print data. The controller 310 stores the document image input by the document image acquirer in page memory 1.

Next, the controller 310 outputs the document image from page memory 1 to the image former 330 ((2)-2 output image), and the image former 330 forms an image on a sheet (printed sheet) based on the document image. After the completion of the sheet ejection, the image former 330 gives a notification indicating the completion of the sheet ejection to the controller 310 ((3)-2 completion of output).

Next, the controller 310 instructs the image reader 340 to read the image formed by the image former 330 ((4)-2 image reading instruction). The image reader 340 reads the image formed by the image former 330, stores the read image in page memory 2, and gives a notification indicating that the reading has been completed to the controller 310 ((5)-2 completion of image reading).

Next, the controller 310 instructs the storage device 390 to read the reference image ((6)-2 read reference image), and reads the reference image from the storage device 390 to page memory 1.

Next, the controller 310 instructs the image inspector 350 to perform image inspection ((7)-2 image inspection instruction). The image inspector 350 acquires the reference image and the read image from page memory 1 and page memory 2, respectively, and inspects the inspection image by comparing the reference image with the read image. Then, the image inspector 350 gives the result of inspecting the inspection image to the controller 310 ((8)-2 result of inspecting image).

The controller 310 repeats the processes (1)-2 to (8)-2 described above until the inspection is completed for all the pages of the printed product as an object for inspection.

In response to an instruction from the user, the controller 310 performs control such that the result (indicating a non-defective product or a defective product) of inspecting the printed product is displayed on the operation display 360 or the display of the client terminal 200, on the basis of the result of inspecting the inspection image.

### [Second Inspection Mode]

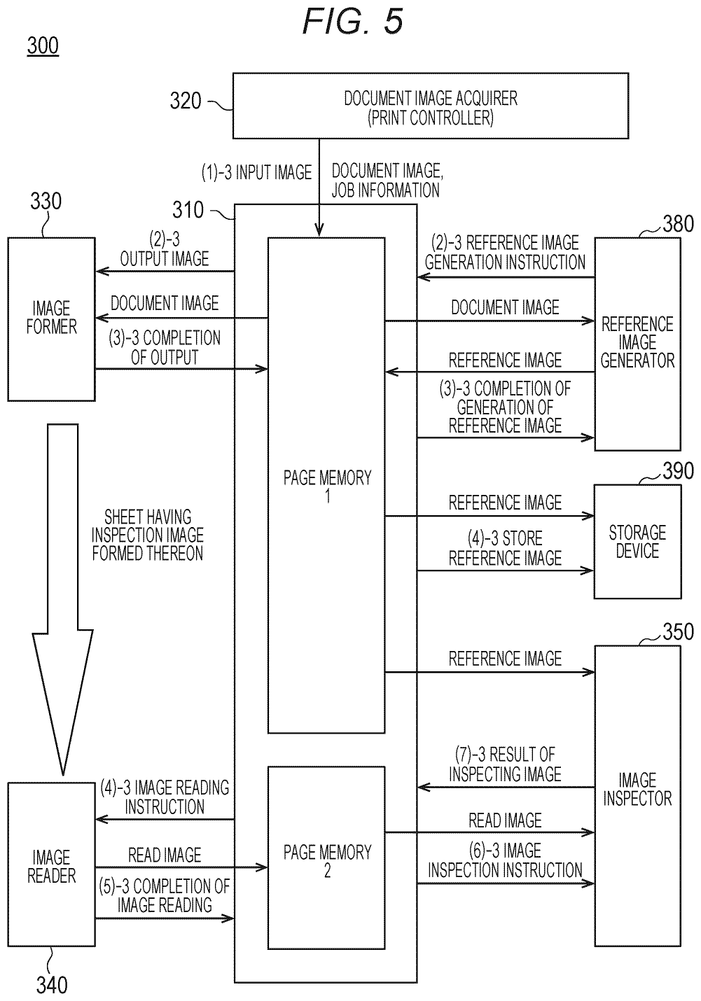

FIG. 5 is a block diagram for describing the outline of a control operation of the controller 310 and the print controller 320 in the second inspection mode.

First, the controller 310 receives a document image and job information from the document image acquirer ((1)-3 input image). The document image is a RIP image obtained by rasterizing print data. The controller 310 stores the document image input by the document image acquirer in page memory 1.

When receiving a reference image generation instruction from the controller 310 ((2)-3 reference image generation instruction), the reference image generator 380 generates a reference image based on the document image acquired by the document image acquirer and outputs the reference image to the controller 310. The controller 310 stores the reference image in page memory 1. As described above, the reference image generator 380 generates the reference image by performing various kinds of processing on the document image in terms of position, resolution, color, and the like.

In addition, upon receiving the document image from the document image acquirer, the controller 310 instructs the image former 330 to form an image and outputs the document image stored in page memory 1 to the image former 330 ((2)-3 output image). In the present embodiment, the image former 330 forms an inspection image on a sheet based on the document image. The generation of the reference image by the reference image generator 380 and the formation of the inspection image by the image former 330 are executed in parallel.

After completing the generation of the reference image, the reference image generator 380 gives a notification indicating that the generation of the reference image has been completed to the controller 310 ((3)-3 completion of generation of reference image). Furthermore, when completing the image formation on the sheet, the image former 330 gives a notification indicating the completion of output to the controller 310 ((3)-3 completion of output). The storage device 390 stores the generated reference image ((4)-3 store reference image).

Further, the controller 310 outputs an image reading instruction to the image reader 340 immediately after receiving the notification indicating the completion of the output ((4)-3 image reading instruction). The image reader 340 reads the sheet on which the inspection image is formed, and outputs the read image of the sheet to the controller 310. The controller 310 stores the read image in page memory 2. When completing reading the sheet, the image reader 340 gives a notification indicating that the image reading has been completed ((5)-3 completion of image reading).

Upon receiving the notification indicating that the image reading has been completed, the controller 310 outputs an image inspection instruction to the image inspector 350 ((6)-3 image inspection instruction). The image inspector 350 acquires the reference image and the read image from page memory 1 and page memory 2, respectively, and inspects the inspection image by comparing the reference image with the read image. Then, the image inspector 350 outputs the result of inspecting the inspection image to the controller 310 ((7)-3 result of inspecting image).

The controller 310 repeats the processes (1)-3 to (7)-3 described above until the inspection is completed for all the pages of the printed product as an object for inspection.

In response to an instruction from the user, the controller 310 performs control such that the result (indicating a non-defective product or a defective product) of inspecting the printed product is displayed on the operation display 360 or the display of the client terminal 200, on the basis of the result of inspecting the inspection image.

### <Image Inspection Method by Image Forming System 300>

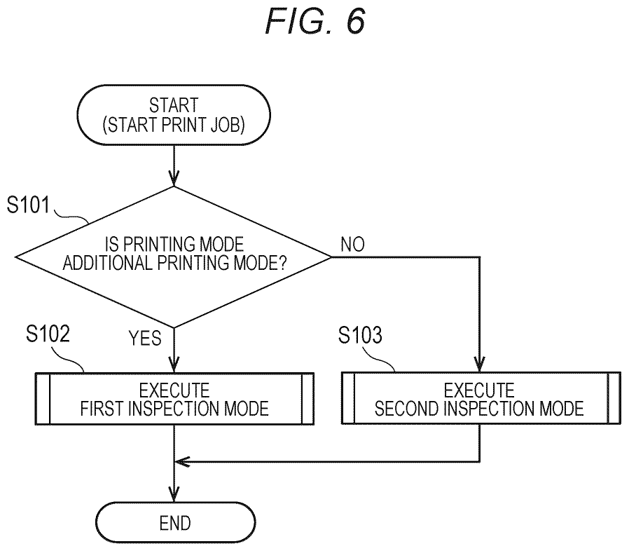

FIG. 6 is a flowchart illustrating a processing procedure of an image inspection method performed by the image forming system 300 illustrated in FIG. 1. The processing illustrated in FIG. 6 is implemented by the image control CPU 311 executing the image inspection program. The case where the printing mode is the additional printing mode will be described below as an example of the case where the reference image needs to be registered in advance.

First, when a print job is started, the controller 310 determines whether or not the printing mode is the additional printing mode (step S101). When the printing mode is the additional printing mode (step S101: YES), the controller 310 executes the first inspection mode. On the other hand, when the printing mode is not the additional printing mode (step S101: NO), the controller 310 executes the second inspection mode.

In the above description, it is determined whether the inspection mode to be executed is the first inspection mode or the second inspection mode based on the selected printing mode. However, designation of the inspection mode may be received from the user, and it may be determined whether the received inspection mode is the first inspection mode or the second inspection mode.

### [First Inspection Mode]

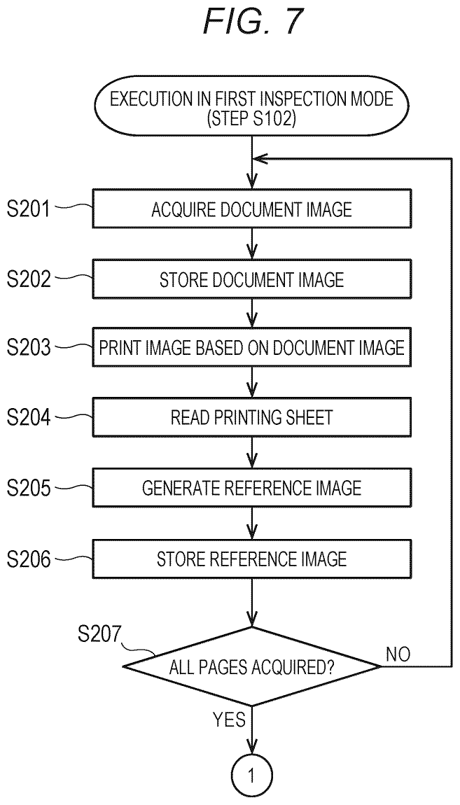

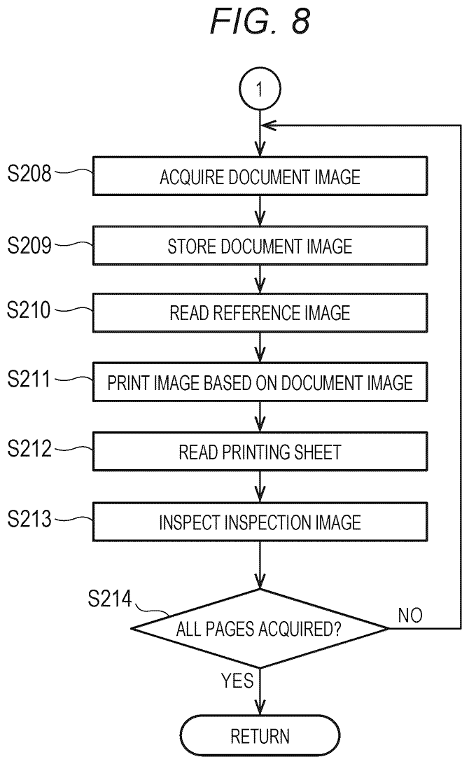

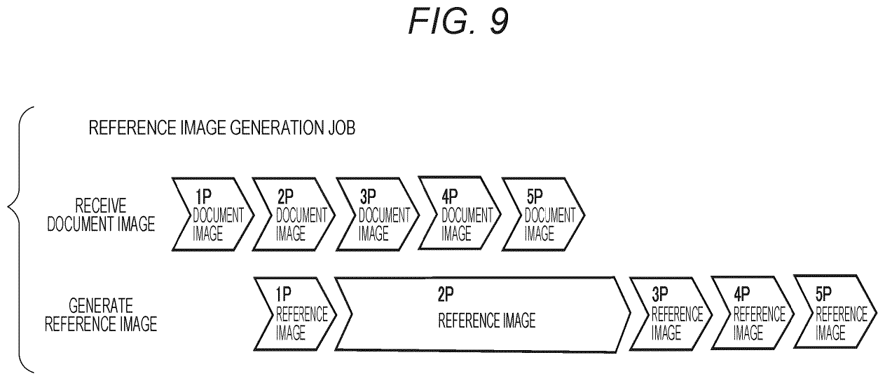

FIG. 7 is a subroutine flowchart illustrating processing (step S102) of executing the first inspection mode in the flowchart illustrated in FIG. 6. FIG. 8 is a subroutine flowchart subsequent to FIG. 7. The processing illustrated in FIGS. 7 and 8 is implemented by the image control CPU 311 executing the image inspection program. FIG. 9 is a schematic diagram illustrating, in a time-series manner, processing of acquiring a document image and processing of generating a reference image in the reference image generation process. FIG. 10 is a schematic diagram illustrating, in a time-series manner, processing of acquiring a document image, processing of forming an inspection image, and processing of inspecting the inspection image in the image forming process.

As illustrated in FIG. 7, first, the controller 310 acquires a document image (step S201). The controller 310 sequentially receives, from the document image acquirer, the first page to the last n-th page of the document image (RIP image) page by page in order from the first page to the last n-th page. For example, FIG. 9 illustrates a case where the first to eighth pages of the document image are sequentially received. In FIGS. 9, 10, and 12, “1P” represents the first page (the same applies to “2P” and the like). Note that the time required to generate the reference image can be different for each page depending on the number of inspection regions and/or inspection exclusion regions, inspection settings, and the like. The reason why the time required to generate a reference image is different for each page is, for example, the complexity of the content. FIG. 9 illustrates an example in which it took time to generate the reference image for the second page.

Next, the controller 310 stores the document image (step S202). When the print job is started, the controller 310 stores the document image acquired from the document image acquirer page by page in page memory 1.

Next, the controller 310 prints an image based on the document image (step S203). The controller 310 controls the image former 330 so that the image former 330 forms an image on a sheet (printed sheet) based on the document image and the job information received from the document image acquirer. For example, the controller 310 performs “printing preparation” and causes the image former 330 to form an inspection image on a sheet based on the document image of the first page. The image former 330 forms an image of the first page of the document image on a sheet in accordance with an instruction from the controller 310. After the image of the first page of the document image is formed, an image of the second page of the document image is similarly formed on the sheet. The “printing preparation” includes initial setting and preparation (for example, warm-up of a fixer) of each section according to an image forming condition in the image former 330.

Next, the image reader 340 reads the image formed on the printing sheet (step S204) and sends it as a read image to the controller 310. The controller 310 stores the read image received from the image reader 340 in page memory 2.

Next, the reference image generator 380 generates a reference image (step S205). The reference image generator 380 generates the reference image to be used for inspection of the inspection image according to an instruction from the controller 310. As illustrated in FIG. 9, when, for example, the first page of the document image is acquired and stored in page memory 1, the controller 310 causes the reference image generator 380 to generate the reference image based on the first page of the document image. The reference image generator 380 generates a reference image based on the first page of the document image. A reference image is similarly generated for the second page of the document image.

Next, the storage device 390 stores the reference image generated by the reference image generator 380 (step S206). For example, the storage device 390 stores the first page and the second page of the document image.

Next, the controller 310 determines whether or not all pages have been acquired (step S207). When all pages of the document image have not been acquired for the printed product as an object for inspection (step S207: NO), the controller 310 proceeds to the process of step S201. On the other hand, when all pages of the document image have been acquired (step S207: YES), the controller 310 proceeds to the process of step S208 in FIG. 8.

As illustrated in FIG. 8, the controller 310 acquires the document image (step S208). The document image is an image to be formed on a printed sheet for additional printing.

Next, the controller 310 stores the document image (step S209). The controller 310 stores the document image acquired from the document image acquirer page by page in page memory 1.

Next, the controller 310 reads the reference image (step S210). The controller 310 reads the reference image stored in page memory 1 and outputs the reference image to the image inspector 350.

Next, the image former 330 prints an image based on the document image (step S211). The controller 310 controls the image former 330 so that the image former 330 forms an inspection image on a sheet (printed sheet) based on the document image and the job information received from the document image acquirer. For example, the controller 310 performs printing preparation and controls the image former 330 so that the image former 330 forms an inspection image on a sheet based on the first page of the document image. The image former 330 forms an inspection image based on the first page of the document image on a sheet in accordance with an instruction from the controller 310. After the inspection image is formed based on the first page of the document image, an inspection image is similarly formed on the sheet based on the second page of the document image.

Next, the image reader 340 reads the inspection image formed on the sheet (step S212) and sends it as a read image to the controller 310. The controller 310 stores the read image received from the image reader 340 in page memory 2.

Next, the image inspector 350 inspects the inspection image by comparing the reference image stored in page memory 1 with the read image stored in page memory 2 (step S213).

Next, the controller 310 determines whether or not all pages of the document image have been acquired for the printed product as an object for inspection (step S214). When all pages have not been acquired (step S214: NO), the controller 310 proceeds to the process of step S208. On the other hand, when all pages have been acquired (step S214: YES), the controller 310 ends the processing (return).

As described above, in the first inspection mode, the reference image is registered at the predetermined timing. As illustrated in FIG. 10, the predetermined timing can include the timing of acquiring the inspection job. The predetermined timing can also include a timing of starting formation of an image in an inspection job by the image former 330 or a timing during the formation of the image in the inspection job. In a case where the document image includes images of a plurality of pages, the predetermined timing can include a timing during image formation of the inspection image based on at least the first page.

Note that, although the case where the reference image generated based on the document image is generated and registered has been mainly described in the above-described example, the present invention is not limited to such a case, and an image stored in advance in the storage device 390, for example, may be registered as the reference image according to a user's instruction.

### [Second Inspection Mode]

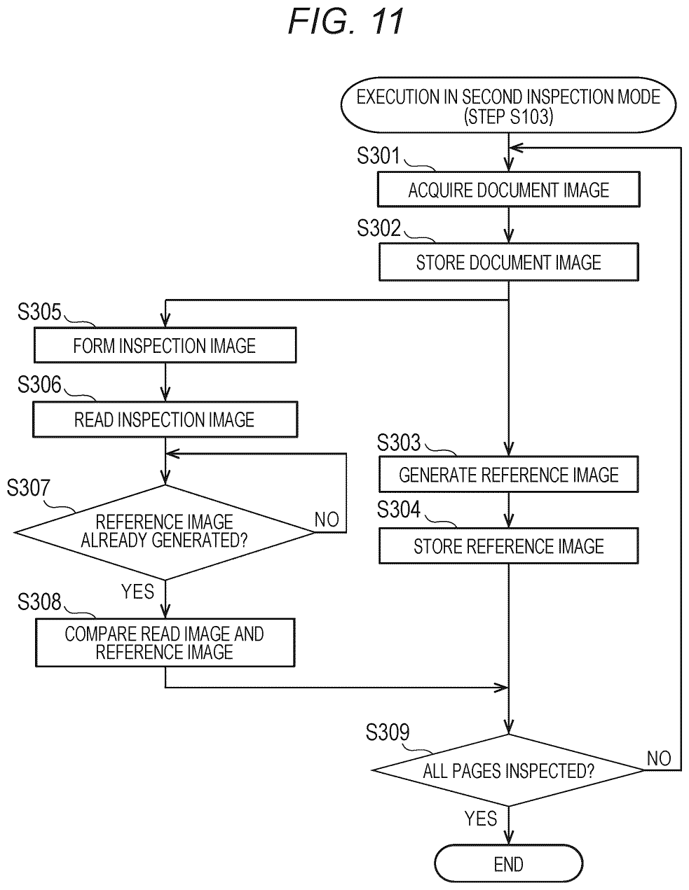

FIG. 11 is a flowchart illustrating a processing procedure of an image inspection method performed by the image forming system 300 in the second inspection mode. The processing illustrated in FIG. 11 is implemented by the image control CPU 311 executing the image inspection program. FIG. 12 is a schematic diagram illustrating, in a time-series manner, processing of acquiring a document image, processing of generating a reference image, processing of forming an inspection image, and processing of inspecting the inspection image.

As illustrated in FIG. 11, first, the controller 310 acquires a document image (step S301). The controller 310 sequentially receives, from the document image acquirer, the first page to the last n-th page of the document image (RIP image) page by page in order from the first page to the last n-th page. For example, FIG. 12 illustrates a case where the first to eighth pages of the document image are sequentially received.

Next, the controller 310 stores the document image (step S302). When the print job is started, the controller 310 stores the document image acquired from the document image acquirer page by page in page memory 1.

Next, the controller 310 controls generation of a reference image to be used for inspection of the inspection image. The reference image generator 380 generates a reference image in accordance with an instruction from the controller 310 (step S303). For example, when the first page of the document image is acquired and stored in page memory 1, the controller 310 controls the reference image generator 380 so that the reference image generator 380 generates the reference image based on the first page of the document image. The reference image generator 380 generates a reference image based on the first page of the document image. A reference image is similarly generated for the second page of the document image.

Next, the storage device 390 stores the reference image generated by the reference image generator 380 (step S304). For example, the storage device 390 stores the first page and the second page of the document image. In addition, in the present embodiment, the controller 310 controls the image former 330 so that the image former 330 forms an inspection image on a sheet based on the document image and the job information received from the document image acquirer, in parallel with the processes of steps S303 and S304, as illustrated in FIG. 11. For example, the controller 310 performs printing preparation and controls the image former 330 so that the image former 330 forms an inspection image on a sheet based on the first page of the document image. The image former 330 forms an inspection image based on the first page of the document image on a sheet in accordance with an instruction from the controller 310 (step S305). After the inspection image based on the first page of the document image is formed, an inspection image based on the second page of the document image is similarly formed on the sheet.

Next, the image reader 340 reads the inspection image formed on the sheet (step S306).

Next, the image inspector 350 determines whether or not a reference image has been generated for each page of the acquired document image (step S307). When the reference image has been generated (step S307: YES), the image inspector 350 compares the reference image and the read image to inspect the inspection image (step S308).

The controller 310 repeats the processes of steps S301 to S308 until the inspection of the inspection images is completed for all the pages (from the first page to the last n-th page) (step S309).

On the other hand, when the reference image has not been generated (step S307: NO), the image inspector 350 waits until the reference image is generated. For example, when the reference image based on the same document image (first page) as the document image (first page) serving as the source of the inspection image to be inspected in step S308 has not been generated, the image inspector 350 waits until the reference image based on the document image (first page) is generated.

As described above, in the second inspection mode, the reference image is not registered at the predetermined timing. As illustrated in FIG. 12, the predetermined timing can include the timing of acquiring the print job. The predetermined timing can also include a timing of starting formation of an image in a print job by the image former 330 or a timing during the formation of the image in the print job. In the second inspection mode, a reference image may not be registered at the predetermined timing.

As illustrated in FIG. 11, the generation of the reference image by the reference image generator 380 and the formation and inspection of the inspection image by the image former 330 are performed in parallel. Thus, the image forming system 300 can further shorten the time required for the processing from the generation of the reference image to the image inspection as compared with the conventional technology.

### [Generation of Reference Image and Formation of Inspection Image on Sheet to be Performed in Parallel]

For example, in the example illustrated in FIG. 12, the generation of the reference images based on the first page (1P) and the second page (2P) and the printing preparation are executed in parallel, and the generation of the reference image based on the third page (3P) and the formation (first half) of the inspection image based on the first page (1P) are executed in parallel. After that, the generation of the reference image based on the fourth page (4P) and the formation of the inspection image based on the first page (1P) (second half) are executed in parallel. Note that, although the generation of the reference image based on the third page (3P) and the formation of the inspection image based on the first page (1P) are illustrated as being started at the same time in FIG. 12, it is not limited thereto. The formation of the inspection image based on the first page (1P) can be started at an appropriate timing after the completion of the printing preparation, and the generation of the reference image based on the third page (3P) can be started at an appropriate timing after the generation of the reference image based on the second page (2P). The timing of starting the generation of the reference image and the timing of starting the generation of the inspection image are similar for the subsequent pages.

### [Generation of Reference Image, Formation of Inspection Image on Sheet, and Inspection of Inspection Image to be Performed in Parallel]

Thereafter, the generation of the reference image based on the fifth page (5P), the formation of the inspection image based on the second page (2P), and the inspection of the inspection image based on the first page are executed in parallel.

As described above, in the present embodiment, while the reference image is generated upon receipt of the document image (the generation of the reference image is triggered by the reception of the document image), the inspection image is formed on the sheet and is inspected when the printing preparation is completed. In the present embodiment, the generation of the reference image and the formation and inspection of the inspection image are performed in parallel, whereby it is possible to shorten the time required for the processing from the generation of the reference image to the image inspection. As a result, the productivity of a printed product is improved.

The image inspection apparatus according to the present embodiment described above provides the following effects.

A printed product obtained by printing that needs pre-registration of a reference image can be appropriately inspected while improving the productivity of inspection of a printed product obtained by printing that does not need pre-registration of a reference image.

As described above, the image inspection apparatus, the image inspection method, and the image inspection program have been described in the embodiment. However, it is obvious that those skilled in the art can appropriately make addition, modifications, and omissions with respect to the present invention within the scope of the technical idea thereof.

For example, although the above embodiment has described the case of generating a document image based on a print job, the present invention is not limited to such a case. The image former 330 may include an image reading device 333 (see FIG. 1) that reads a document prepared by a user, and may be configured to generate a document image based on an image generated by reading the document by the image reading device 333. The image reading device 333 reads, for example, a document conveyed to a predetermined reading position by an automatic document feeder using a scanner, and generates image data.

Furthermore, the image inspection program may be provided by a computer-readable recording medium, such as a USB memory, a flexible disk, or a CD-ROM, or may be provided online via a network, such as the Internet. In this case, the image inspection program recorded on the computer-readable recording medium is usually transferred to and stored in a memory, a storage, or the like. Alternatively, the image inspection program may be provided, for example, as independent application software, or may be incorporated into software of each device as a function of a server.

Furthermore, a part or a whole of the processing performed by the image inspection program in the embodiment can be performed in the form of hardware such as circuits.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image inspection apparatus comprising:
an image former that forms an image on a recording medium on the basis of acquired image data; and
a hardware processor,
the hardware processor generating a reference image to be used for inspection of the image formed on the recording medium, and inspecting the image formed on the recording medium on the basis of the reference image,
the image inspection apparatus having a first inspection mode in which the reference image is registered at a predetermined timing in an image forming process of forming the image to be inspected by the image former and a second inspection mode in which the reference image is not registered at the predetermined timing.

2. The image inspection apparatus according to claim 1, wherein the predetermined timing includes a timing of acquiring a job based on the image data.

3. The image inspection apparatus according to claim 1, wherein the predetermined timing includes a timing of starting image formation by the image former.

4. The image inspection apparatus according to claim 1, wherein the predetermined timing includes a timing during image formation by the image former.

5. The image inspection apparatus according to claim 4, wherein
the image data is image data for forming images of a plurality of pages on a recording medium, and
the predetermined timing includes a timing during image formation of at least a first page.

6. The image inspection apparatus according to claim 1, wherein the generation of the reference image and the formation of the image on the recording medium are performed in parallel in the second inspection mode.

7. The image inspection apparatus according to claim 1, wherein
the hardware processor controls the image former, and
when the second inspection mode is designated, the hardware processor executes, in parallel, a reference image generation process including generation of the reference image and an inspection process including formation of the image on the recording medium by the image former and inspection of a read image generated by reading the recording medium on which the image is formed.

8. The image inspection apparatus according to claim 1, wherein the reference image registered in the first inspection mode is a read image generated by reading the recording medium.

9. The image inspection apparatus according to claim 1, wherein the first inspection mode is selected when inspection for additional printing is performed.

10. An image inspection method performed by an image inspection apparatus, the image inspection method comprising:
forming an image on a recording medium on the basis of acquired image data;
generating a reference image to be used for inspection of the image formed on the recording medium; and
inspecting the image formed on the recording medium on the basis of the reference image,
the image inspection apparatus having a first inspection mode in which the reference image is registered at a predetermined timing in an image forming process of forming the image to be inspected and a second inspection mode in which the reference image is not registered at the predetermined timing.

11. A computer-readable recording medium storing an image inspection program for causing a computer to execute the image inspection method according to claim 10.
